(19) United States
(12) Patent Application Publication
(10) Pub. No.: US 2018/0014560 A1
(43) Pub. Date: Jan. 18, 2018

(54) COOKING METHOD FOR FORMING COOKED EGG PRODUCT

(71) Applicant: Charlotte Waltz, Norman, IN (US)

(72) Inventor: Charlotte Waltz, Norman, IN (US)

(21) Appl. No.: 15/194,167

(22) Filed: Jun. 27, 2016

Related U.S. Application Data
(60) Provisional application No. 62/185,934, filed on Jun. 29, 2015.

(51) Int. Cl. A47J 29/02; A47J 27/04

(52) U.S. Cl. CPC A23L 5/13; A47J 29/02; A23L 15/00; A47J 27/04; A47J 2027/043

(57) ABSTRACT

Cooking eggs includes placing a shelled egg within a cup-shaped mold, and positioning the mold in a water bath. The water bath is contained in a cooking vessel, heated to generate steam for a period of time sufficient to cook the yolk and white of the egg. The cooking vessel is covered during the heating so as to form a finish on the cooked yolk and white that approximates hard-boiling.

### FIELD OF THE INVENTION

The present disclosure relates generally to cooking techniques, and more particularly to methodology for egg cooking that simulates hard boiling in a shelled egg.

### BACKGROUND

Cooking an ideal hard-boiled egg has been the subject of experimentation for literally centuries. Various factors such as altitude, starting water temperature, agitation of eggs in the shell during cooking, and still other factors can affect the finish or other properties of the final cooked egg product. Food science literature is replete with research on cooking eggs in the shell, and cooking techniques for shelled eggs as well. There nevertheless remains room for improvement.

### BRIEF SUMMARY

Cooking an egg includes placing a shelled egg within a cup-shaped mold such that the yolk and white partially fill the mold, and positioning the mold in a water bath such that a base of the mold is in contact with a floor of a cooking vessel containing the water bath, and the lip of the mold is above the level of the water. The methodology further includes heating the cooking vessel so as to heat the water to generate steam, for a period of time sufficient to cook the yolk and white. The methodology still further includes covering the cooking vessel during the heating such that the steam is circulated within the cooking vessel so as to form a finish on the cooked yolk and white that approximates that of hard-boiling.

### BRIEF DESCRIPTION OF THE DRAWINGS

FIG. 1 is a sectioned side diagrammatic view of a cooking set up, according to one embodiment;

FIG. 2 is an elevational view of a cooked egg product within a mold, according to one embodiment;

FIG. 3 is a view, in perspective, of a cooked egg product, according to one embodiment; and

FIG. 4 is a sectioned view taken along line 4-4 of FIG. 3.

### DETAILED DESCRIPTION

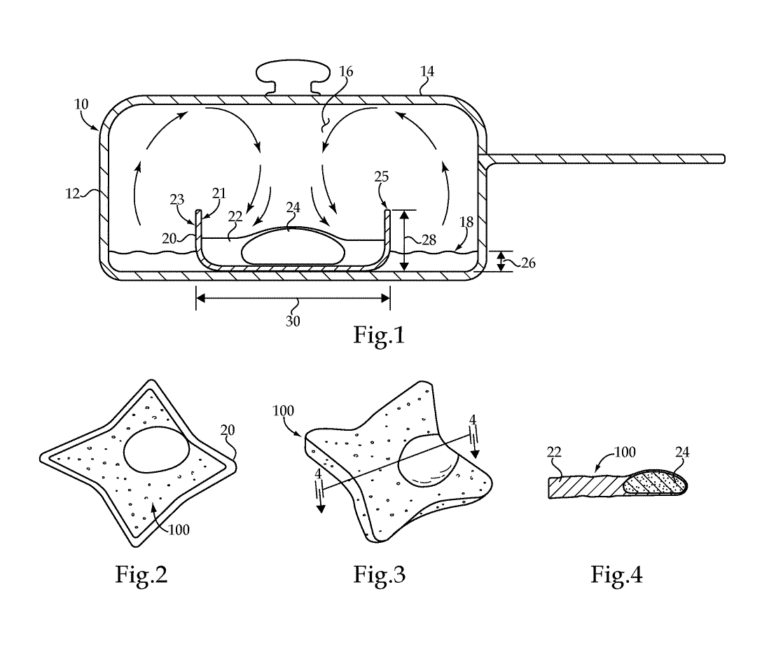

Referring to FIG. 1, there is shown a cooking system 10 according to one embodiment. System 10 includes a cooking vessel 12 having an interior 16 and being covered with a lid 14. A shelled egg having a yolk 24 and a white 22 has been placed within a cup-shaped mold 20 of cooking system 10 such that yolk 24 and white 22 partially fill mold 20. Mold 20 is positioned in a water bath such that a base of the mold is in contact with a floor of cooking vessel 12 containing water bath 18. A lip 25 of mold 20 is above a level of the water forming water bath 18. In the illustrated embodiment, cooking vessel 12 is heated so as to heat the water forming water bath 18 to generate steam, with the heating occurring for a period of time sufficient to cook yolk 24 and white 22. Cooking vessel 12 is covered via lid 14 during the heating such that steam, shown via arrows within interior 16 in FIG. 1, circulates within cooking vessel 12 so as to form a finish on the cooked yolk 24 and white 22 that approximates that of hard-boiling. The described “circulation” of steam should be understood to mean that the steam moves about in paths that curve so as to bring steam downward and into contact with the shelled egg, but not necessarily in a circular or toroidal or any other particular path. Heating from the bottom, in conjunction with heating via the steam and to an extent the water bath itself cooks yoke 24 and white 22.

As alluded to above, a variety of different factors can affect the success of any cooking technique, but particularly a cooking technique where an egg is to be cooked in a manner that approximates hard-boiling. It has been discovered that certain factors or parameters that can be manipulated by a user of system 10 can be specified in such a manner as to produce a cooked egg product that is not undercooked and not overcooked, but instead cooked to approximate ideal hard-boiling. One such factor is considered to be water bath depth. In one embodiment, a depth 26 of water bath 18 may be about one-half inch or less. In a refinement, depth 26 of water bath 18 may be about one-eighth inch. A depth 28 of cup-shaped mold 20, a width of mold 20, and an aspect ratio of width to depth are also factors discovered to influence the ability to ideally cook eggs as contemplated herein. In one practical implementation strategy, depth 28 may be about two inches or less, a width 30 of mold 20 may be about 3 inches or less, most preferably about 2.5 inches or less, and an aspect ratio of width 30 to depth 28 may be from about 3:1 to about 1:1. A volume of a shelled egg cooked according to the present disclosure may be that of a standard large sized chicken egg, and equal to about four tablespoons. For smaller eggs or larger eggs, cooking time and potential dimensions of mold 20 might be varied somewhat. It is nevertheless contemplated that the present dimensions and dimensional ranges disclosed herein will be applicable to cooking eggs in the manner contemplated herein having a range of sizes. It should also be appreciated that although only one mold with one shelled egg is depicted in FIG. 1, in other embodiments multiple cup-shaped molds each containing one yolk and one white of a shelled egg may be cooked together within a common cooking vessel.

Another factor bearing upon the success of cooking an egg according to the present disclosure is the manner in which a cooking vessel is heated. Heating cooking vessel 12 may include applying heat energy to an outside bottom surface of cooking vessel 12 at a level equivalent to result in a dry heated temperature of the floor of cooking vessel 12 in a period of time of about ten minutes to about fifteen minutes that is from about 325° F. to about 425° F. A wattage of the heating element in such an instance might be about 1500 Watts. Such parameters will of course also depend also on the material and construction of the cooking pan. In other words, while the present disclosure contemplates cooking in a water bath, a suitable heating level would, if applied to a dry cooking vessel, result in temperatures in the range described. In the case of an electric cookstove the heat setting may be medium heat. In the case of a gas stove, the setting may be medium low heat. In either case, heating may commence at around the same time, or possibly slightly after, covering cooking vessel 12 with lid 14. A release agent such as butter, a vegetable oil or a vegetable oil spray may be applied to the inside of mold 20, its bottom and sides, prior to placing the shelled egg therein. In a ten-inch skillet or saucepan, water in a volume of about three-quarters of a cup can be placed therein to provide for a suitable depth water bath. Cooking may occur without agitation, as molds 20 will generally move minimally within cooking vessel 12 during cooking. Cooking time may be about 12 minutes to about 14 minutes, in some embodiments substantially equal to 13 minutes, after which cooking vessel 12 may be removed from the heat, opened, and mold 20 removed via tongs and flipped over onto a plate to enable the cooked egg product to slide out of mold 20. Referring to FIG. 2, there is shown cooked egg product 100 still within mold 20 and as it might appear just prior to being removed from mold 20. In FIG. 3, cooked egg product 100 is shown removed from mold 20, and has a general star shape as might be imparted by the non-uniform or varying-contour inside surface of mold 20.

FIG. 4 depicts a sectioned view taken along line 4-4 of FIG. 3. It can be seen from FIG. 4 that yolk 24 has assumed a mealy texture and is encased by a thin layer of cooked egg white 22. It will be recalled that the finish formed on cooked yolk 24 and white 22 approximates that of hard-boiling. Those skilled in the food science arts will be familiar with undercooked eggs as well as overcooked eggs. In the case of undercooked eggs, a yolk does not achieve a mealy texture, but instead remains liquid, gelatinous, and otherwise somewhat flowable. In the case of an overcooked egg, greening of the yolk and even some green staining of the white can occur. According to the present disclosure, a finish that approximates that of hard-boiling should be understood to be a finish where the cooked yolk has a mealy texture, a transition that occurs relatively distinctly from the liquid or gelatinous state, and where the yolk is at least half submerged in the white and substantially free from greening. A cooked yolk and white with a finish approximating hard-boiling can further be understood as having a yolk encased in cooked white.

Proteins in chicken eggs denature at a range of temperatures, and at a range of time periods of heating. A variety of different cooked or partially cooked yoke consistencies can be produced in hard boiled eggs depending upon the manner in which the eggs are heated, including the rate of heating, the rate of cooling, the duration of heating, and potentially still other factors. Food science knowledge and traditional culinary wisdom provide considerable guidance as to producing various consistencies for eggs that are cooked by boiling in the shell as well as by other techniques such as frying and poaching. Simulating a hard boiled finish, in other words a combination of textures and colors of the yoke and the white, in an egg cooked out of the shell is not believed to have been the subject of research or experimentation at all. Eggs cooked out of the shell are typically prepared on a non-stick surface such as a polytetrafluoroethylene coating, in an oil, margarine, or butter, or in a water bath. Eggs cooked according to such techniques can be observed to have browning of the white, varying shape and structure of the white and also the yoke, and in some instances pitting or bubbling. Among other things, the present disclosure reflects the discoveries that optimum aesthetic and culinary quality of an egg cooked out of the shell can be achieved without the labor and mess associated with hard boiling.

As described herein these aims are achieved by way of combining a number of different variables in the cooking process in an advantageous manner. For mold sizes too small, for instance, the egg can be expected to overflow the mold and/or be overcooked because the water bath evaporates and the egg heats too much or too quickly. For mold sizes too large the egg can spread to the point that it no longer has the character of a hard-boiled egg at all, with the yoke failing to be encased in the white. Where the water bath is too deep, boiling water can splash into the mold. Cooked uncovered, steam does not circulate downward and the egg will not cook completely and may not have the desired texture approximating hard boiling.

In the illustrated embodiment, cooked egg product 100 has a rough star shape. It will be understood that a mold surface with any of a great many different contours might be provided, providing an equal variety of mirror-image contours to cooked yolk and white in a finished and cooked egg product. Suitable molds include silicone molds of substantially uniform thickness, such as where a thickness of the silicone mold varies by a factor of 2 or less throughout. In other words, in at least some instance the mold might have a minimum thickness of about “X” and a maximum thickness of about “2X” although the present disclosure is not thereby limited. Additional shapes contemplated within the scope of the present disclosure include hemispheric shapes, other star shapes, heart shapes, and still other polygonal and non-polygonal shapes.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of cooking eggs comprising:
placing a shelled egg within a cup-shaped mold such that the yolk and white partially fill the mold;
positioning the mold in a water bath such that a base of the mold is in contact with a floor of a cooking vessel containing the water bath, and a lip of the mold is above a level of the water;
heating the cooking vessel so as to heat the water to generate steam, for a period of time sufficient to cook the yolk and white; and
covering the cooking vessel during the heating such that the steam is circulated within the cooking vessel so as to form a finish on the cooked yolk and white that approximates that of hard-boiling.

2. The method of claim 1 wherein the placing of the shelled egg includes placing the yolk and white into a cup-shaped mold, and further comprising applying release agent to the mold prior to the placing of the shelled egg.

3. The method of claim 2 wherein the mold is formed of silicone and has a mold surface with a varying contour that imparts a mirror-image contour to the cooked yolk and white.

4. The method of claim 1 wherein the heating of the cooking vessel includes applying heat energy to an outside bottom surface of the cooking vessel at a level equivalent to result in a dry heated temperature of the floor that is from about 325 degrees F. to about 425 degrees F.

5. The method of claim 4 wherein the shelled egg is one of a plurality of shelled eggs within a plurality of cup-shaped molds positioned within the water bath.

6. The method of claim 5 wherein a depth of each of the plurality of cup-shaped molds is about two inches or less, a width of each of the plurality of cup-shaped molds is about three inches or less, and an aspect ratio of the widths to the depths is from about 3:1 to about 1:1, and wherein a volume of each of the shelled eggs is about four tablespoons or greater.

7. The method of claim 6 wherein a depth of the water bath is about ½ inch or less.

8. The method of claim 6 wherein the depth of the water bath is about ⅛ inch.

9. The method of claim 4 wherein the heating of the cooking vessel includes heating the cooking vessel for about 12 minutes to about 14 minutes, and further comprising removing the mold with the yolk and white therein approximately at the end of the heating.

10. The method of claim 3 wherein a thickness of the mold varies by a factor of about 2 or less throughout.
